(19) United States
(12) Patent Application Publication
(10) Pub. No.: US 2018/0101371 A1
(43) Pub. Date: Apr. 12, 2018

(54) DEPLOYMENT MANAGER

(71) Applicant: Microsoft Technology Licensing, LLC, Redmond, WA (US)

(72) Inventors: Michael C. Flanakin, Seattle, WA (US); Guruprasad M. Airy, Redmond, WA (US); Katherine M. Spengler, Kirkland, WA (US)

(73) Assignee: Microsoft Technology Licensing, LLC, Redmond, WA (US)

(21) Appl. No.: 15/290,432

(22) Filed: Oct. 11, 2016

(51) Int. Cl. G06F 9/445; G06F 9/44; G06F 3/0484

(52) U.S. Cl. CPC G06F 8/60; G06F 3/0484; G06F 8/33

(57) ABSTRACT

An application platform in a cloud environment includes a portal to provide user access to a deployment manager. The deployment manager includes a user interface, a template library, a template editor, and a deployment mechanism. The user interface is configured in the portal. The template library includes a set of preconfigured templates, and each preconfigured template corresponds with one or more resources of the application platform. The template library is accessible via the user interface. The template editor receives one or more preconfigured templates from the set of preconfigured templates and facilitates user modification of the preconfigured template via the user interface. The deployment mechanism deploys a user-modified preconfigured template in the application platform via the user interface.

### BACKGROUND

Cloud computing is a model of service delivery for enabling convenient, on-demand network access to a shared pool of configurable computing resources that can be rapidly generated and released with nominal management effort or interaction with a provider of the service. Cloud computing allows a cloud consumer to obtain computing resources, such as networks, network bandwidth, servers, processing memory, storage, applications, virtual machines, and services as a service on an elastic and sometimes impermanent basis. Cloud computing platforms and infrastructures allow developers to build, deploy, and manage and resources for applications.

### SUMMARY

This summary is provided to introduce a selection of concepts in a simplified form that are further described below in the Description. This summary is not intended to identify key features or essential features of the claimed subject matter, nor is it intended to be used to limit the scope of the claimed subject matter.

Application platforms provide resources and infrastructure to deploy applications in cloud-computing environments. Declarative templates, such as JSON documents, can be used define the resources and configurations of the application. Templates can include large and intricate documents in a particular syntax, and the creation or acquisition of templates and template deployment provides an additional level of complexity for developers in using the application platform.

An application platform in a cloud environment includes a portal to provide access to a deployment manager. The deployment manager includes a user interface, a template library, a template editor, and a deployment mechanism. The user interface is configured in the portal. The template library includes a set of preconfigured templates, and each preconfigured template corresponds with one or more resources available within the application platform. The template library is accessible via the user interface. The template editor receives a preconfigured template from the set of preconfigured templates and facilitates user modification of the preconfigured template via the user interface. The deployment mechanism deploys a user-modified preconfigured template in the application platform via the user interface.

### BRIEF DESCRIPTION OF THE DRAWINGS

The accompanying drawings are included to provide a further understanding of embodiments and are incorporated in and constitute a part of this disclosure. The drawings illustrate embodiments and together with the description serve to explain principles of embodiments. Other embodiments and many of the intended advantages of embodiments will be readily appreciated, as they become better understood by reference to the following description. The elements of the drawings are not necessary to scale relative to each other. Like reference numerals designate corresponding similar parts.

FIG. 1 is a block diagram illustrating an example of a computing device, which can be configured in a computer network to provide, for example, a cloud-computing environment.

FIG. 2 is a schematic diagram illustrating an example application platform in a cloud-computing environment.

FIG. 3 is a schematic diagram illustrating an example deployment manager of the application platform of FIG. 2.

FIG. 4 is a block diagram illustrating an example method of the deployment manager of FIG. 3.

### DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various exemplary embodiments described herein may be combined with each other, unless specifically noted otherwise.

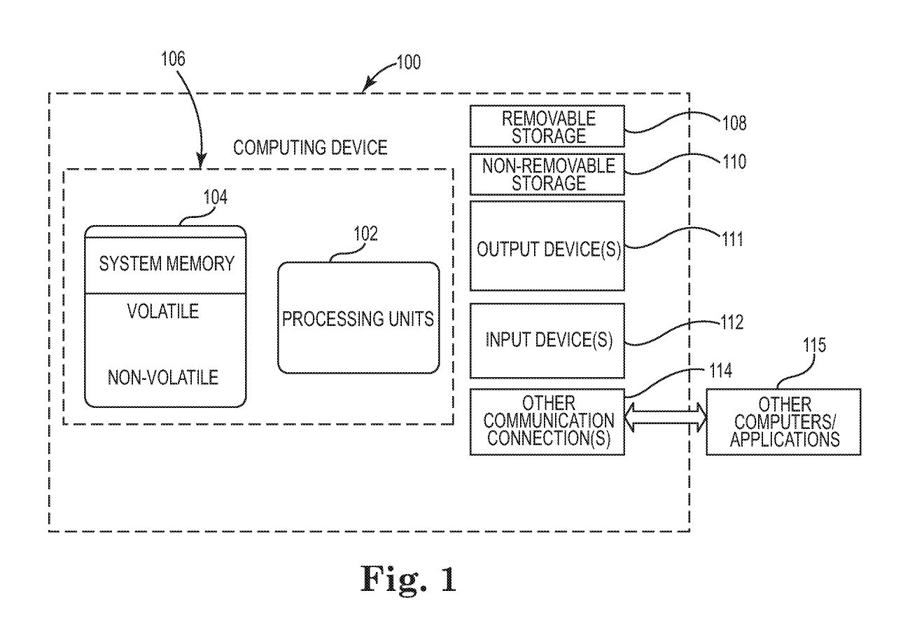

FIG. 1 illustrates an exemplary computer system that can be employed in an operating environment and used to host or run a computer application included on one or more computer readable storage mediums storing computer executable instructions for controlling the computer system, such as a computing device, to perform a process. An example of a computer-implemented process includes a deployment manager, such as a deployment manager network application in an application platform for a cloud-computing environment that can be stored in a computer memory.

The exemplary computer system includes a computing device, such as computing device 100. In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two. The computing device 100 can take one or more of several forms. Such forms include a tablet, a personal computer, a workstation, a server, a handheld device, a consumer electronic device (such as a video game console or a digital video recorder), or other, and can be a stand-alone device or configured as part of a computer network.

Computing device 100 can also have additional features or functionality. For example, computing device 100 may also include additional storage. Such storage may be removable and/or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse, track pad), stylus, voice input device, touch input device (e.g., touchscreen), or other. Output devices 111 may include devices such as a display, speakers, printer, or the like.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the Internet, or other network.

In one example, a one or more of computing devices 100 can be configured as servers in a datacenter to provide distributed computing services such as cloud computing services. A data center can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 100 can be configured as servers, either as stand alone devices or individual blades in a rack of one or more other server devices. One or more host processors, such as processors 102, as well as other components including memory 104 and storage 110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible, distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

A hybrid cloud is a deployment model that includes two or more clouds, such as private clouds, public clouds, and community clouds or combinations of two or more of each deployment model, that remain unique entities. Hybrid clouds include technology to bind together the two or more clouds, and in some examples permit data and application portability across clouds, such as cloud bursting for load balancing, and service interoperability.

Cloud-computing providers generally offer services for the cloud-computing environment as a service model provided as one or more of an infrastructure as a service, platform as a service, and other services including software as a service. Cloud-computing providers can provide services via a subscription to tenants or consumers. For example, software as a service providers offer software applications as a subscription service that are generally accessible from web browsers or other thin-client interfaces, and consumers do not load the applications on the local computing devices.

Infrastructure as a service providers offer consumers the capability to provision processing, storage, networks, and other fundamental computing resources where the consumer is able to deploy and run software, which can include operating systems and applications. The consumer generally does not manage the underlying cloud infrastructure, but generally retains control over the computing platform and applications that run on the platform.

Platform as a service providers offer the capability for a consumer to deploy onto the cloud infrastructure consumer-created or acquired applications created using programming languages, libraries, services, and tools supported by the provider. In some examples, the consumer does not manage or control the underlying cloud infrastructure including network, servers, operating systems, or storage, but has control over the deployed applications and possibly configuration settings for the application-hosting environment.

In other examples, the provider can offer a combination of infrastructure and platform services to allow a consumer to manage or control the deployed applications as well as the underlying cloud infrastructure. Platform as a service providers and include infrastructure, such as servers, storage, and networking, and also middleware, development tools, business intelligence services, database management services, and more, and can be configured to support the features of the application lifecycle including one or more of building, testing, deploying, managing, and updating.

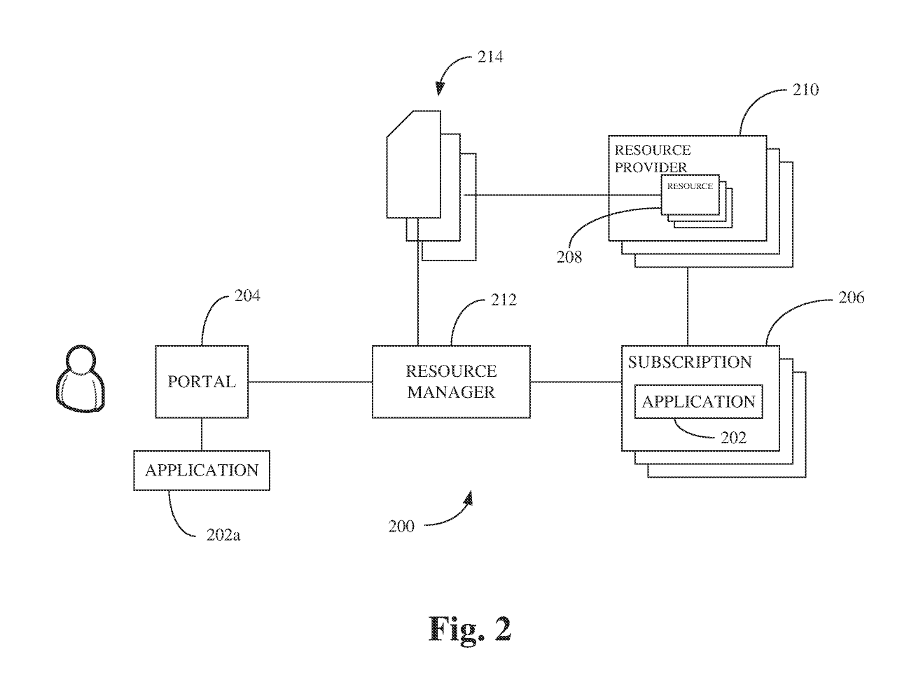

FIG. 2 illustrates an example application platform 200 in a cloud-computing environment, such as a public cloud, to deploy applications across selected datacenters. In the illustrated example, a user, including a developer, can create an application 202a locally with an integrated development environment using one or more development technologies or otherwise create or acquire the application. In another example, the integrated development environment can be included as part of the application platform 200. The application platform 200 provides capabilities to the consumers to deploy the created or acquired application 202 to the cloud computing environment and address infrastructure issues.

The application platform 200 in the example includes an interface, such as portal 204, to provide user access to and user administration of features of the platform. In one example, the portal 204 can be configured in distributed application structure, for example a web application for running in a thin-client interface such as a browser, and provide access to one or more service subscriptions 206 to deploy the application 202 in the cloud-computing environment.

The application platform 200 includes, or includes access to, resources 208 available from one or more resource providers 210. A resource 208 can include a component of the application to be provisioned in the platform subscription 206 and provides an item of the platform solution. Examples of resources 208 can include virtual machines, databases, virtual networks, and others. In one example, resources 208 are user-managed entities in the application platform 200. Resource providers 210 include services that provide resources for the application 202. Resource providers 208 include services to create, configure, and manage operations for working with the resource 208. Examples of resource providers include a compute provider to supply a virtual machine resource, storage provider to supply a storage account resource, web provider to supply resources related to web applications, and other resource providers.

The application platform 200 includes a resource manager 212, accessible via portal 204, as a service to provision resources 208 in the subscription 206. In one example, the resource manager 212 provides the facilities to manually track and manage independent resources in the subscription. Resources can be individually created or deleted, and resources can be deployed in a correct order via a template executed by the portal, custom code, or a script. In another example, the resource manager 212 can provide facilities to deploy, manage and monitor services for a solution as a group, logically organize resources in the subscription 206 via the portal 204. For example, the resource manager can include a container to hold a logical grouping of resources, such as related resources, to support a particular application or workload as a resource group. A resource group may include resources that share the same management lifecycle. A resource group can be created to scope access control for administrative actions, and resources can interact with resources from other resource groups. Resource groups provide an integrated mechanism to manage the application resources in a subscription.

Resources 208 can be deployed and managed via resource manager 212 using one or more mechanisms including a declarative templates 214. Application 202 can be provisioned with one or more declarative templates 214. Each template can deploy one or multiple services along with dependencies. The templates 214 can be reused to repeatedly deploy the application 202 during various stages of the application lifecycle. In one example, the template 214 describes a resource in a document provided in a selected data format such as JavaScript Object Notation, or JSON. The resource manager 212 applies the JSON document template 214 to determine which resources exist in the subscription 206 and provisions missing resource 208 that can be used to complete a resource group and to resolve dependencies between resources.

Templates can include large and intricate documents in a particular syntax, and template creation can be a difficult for developers. In some examples, developers can draft new templates using code editors or integrated development environments or acquire existing templates from other developers. The creation or acquisition of templates provides an additional level of complexity for developers in using the application platform.

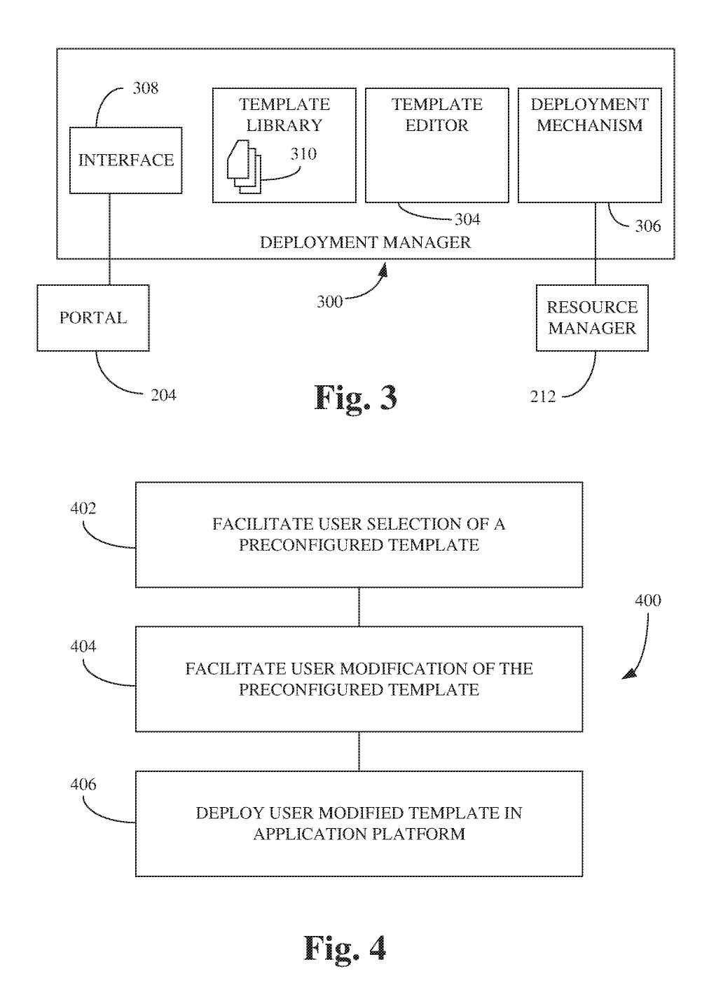

FIG. 3 illustrates an example deployment manager 300 accessible via portal 204 included in the application platform 200 such as a feature of the resource manager 212. The deployment manager 300 includes a template library 302, a template editor 304, and a deployment mechanism 306. The deployment manager 300 can be configured in a distributed application structure, and include a distributed user interface 308 such as a network application running in a thin-client interface. One example architecture pattern of the deployment manager 300 is model-view-controller. The network application can include a web application running in a web browser application. In one example, the user interface 308 is integrated with the portal 204 to access the subscription 206.

The template library 302 includes a collection of preconfigured templates 310 suitable for modification corresponding with various resources 208. In one example, selecting a resource 208 from the portal 204 can automatically provide the corresponding preconfigured template 310 into the template editor 304. In another example, the preconfigured template 310 can be directly selected from the template library 302 and provided to the template editor 304. In one example, the corresponding preconfigured template 308 includes a targeted and purpose-specific template for the corresponding resource 208.

The template editor 304 provides for reviewing and modifying of the templates 214 to customize the deployment. The template editor 304 can be used to modify preconfigured templates 308 selected from the template library as well as to update modified preconfigured templates. The template editor 304 in some examples can be used to specify to the resource manager 212 to delete resources 208. In one example, the template editor 304 can be applied to modify developer-generated or acquired templates for existing resources or a particular deployment. Also, the current state of a resource 208 can be exported to a template in the template editor 304.

The deployment mechanism 306 deploys the modified or preconfigured templates in the template editor 304 with the resource manager 208. In one example, the deployment mechanism 306 leaves unchanged resources that exist in the resource group or subscription that are not specified in the template. The mode of the deployment can be selected via the interface 308. In the example, the deployment mechanism 306 is operable via the interface 308 to allow a user to directly deploy the template from the template editor 304, such as via a user selecting a “deployment button” on a graphic user interface 308 rather than having a user access a task automation and configuration management framework or having a user provide a token to deploy the template from storage.

The preconfigured templates 310 define resources to deploy or update in a resource group or subscription 206, and can specify the parameters and values in various environments and outputs. The template 310 can define a JSON schema file that describes the version of the template language. The parameters can define values that are provided during the execution of the deployment to customize the resource deployment. In one example, the parameters can provide for customized deployment by providing values selected for a particular environment, such as development, testing, and production environments. The variable can define values included in the template language expression, such as values in the JSON fragments. In one example, variables can be based on the parameters. Outputs can include values returned after deployment.

FIG. 4 illustrates an example method 400 of the deployment manager 300 in the application platform 200. The method includes facilitating user selection of a preconfigured template from a template library at 402. The pre-configured template corresponds with one or more resources in the application platform, and selection of the preconfigured template is facilitated with a user interface, such as a graphical user interface in a network application. The user interface also facilitates modification of the preconfigured template at 404. In one example, modification of the preconfigured template is facilitated with a code editor accessible with the user interface. Modification of the preconfigured template creates a modified template. The modified template is deployed into the application platform via the interface at 406. The example method 400 can be implemented to include a combination of one or more hardware devices and programs for controlling a system, such as a computing device 100 having a processor 102 and memory 104, to perform method 400 to deploy templates into the application platform. For example, method 400 can be implemented as a set of executable instructions for controlling the processor 104 to perform method 400, the computer executable instructions stored on a non-transitory medium.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

1. A method of deploying a template in an application platform for a cloud environment, the method comprising:
facilitating user selection of a preconfigured template from a template library on the application platform from a user interface accessing the application platform, the preconfigured template corresponding with and operably coupled to a resource in the application platform;
facilitating user modification of the preconfigured template from the user interface; and
deploying the user-modified preconfigured template from the user interface into a subscription on the application platform from the user interface.

2. The method of claim 1 wherein deploying the user-modified preconfigured template includes facilitating deployment with a user interface.

3. The method of claim 2 wherein the user interface is a graphical user interface.

4. The method of claim 1 wherein the template includes a document in a data format to define the resource in the application platform.

5. The method of claim 4 wherein the data format is a JavaScript Object Notation (JSON) format.

6. The method of claim 4 wherein the template includes parameters that define values provided during deployment.

7. The method of claim 6 wherein the parameters are customizable for development, testing, and production.

8. The method of claim 1 wherein facilitating user modification of the preconfigured template includes facilitating user modification of a deployed user-modified preconfigured template.

9. The method of claim 1 wherein facilitating user modification of the preconfigured template includes deleting the resource from a subscription.

10. An application platform stored on a computer-readable memory device to control a processor in a cloud environment, the application platform comprising:
a portal to provide user access to the application platform; and
a deployment manager, comprising:
a user interface configured in the portal;
a template library having a set of preconfigured templates stored on the application platform, each preconfigured template corresponding with and operably coupled to a resource of the application platform and accessible via the user interface;
a template editor to receive a preconfigured template from the set of preconfigured templates, the template editor to facilitate user modification of the preconfigured template via the user interface;
a deployment mechanism to deploy a user-modified preconfigured template into a user subscription in the cloud environment via the user interface.

11. The application platform of claim 10 including a resource manager to service and provision the resource in a subscription.

12. The application platform of claim 11 wherein the resource manager is accessible via the portal.

13. The application platform of claim 11 wherein the resource manager includes a container having a plurality of resources.

14. The application platform of claim 10 wherein the deployment manager is in a network application structure.

15. The application platform of claim 14 wherein the user interface is configured to run in a thin-client interface.

16. The application platform of claim 10 wherein the template editor includes a code editor.

17. A system to deploy a template in an application platform for a cloud environment, the system comprising:
memory to store a set of instructions; and
a processor to execute the set of instructions to:
facilitate user selection of a preconfigured template from a template library on the application platform from a user interface accessing the application platform, the preconfigured template corresponding with and operably coupled to a resource in the application platform;
facilitate user modification of the preconfigured template from the user interface;
and
deploy the user-modified preconfigured template from the user interface into a subscription on the application platform from the user interface.

18. The system of claim 17 wherein the user interface is configured to run in a thin-client interface.

19. The system of claim 17 wherein the user interface is a graphical user interface.

20. The system of claim of 17 wherein the user-modified template defines a customized deployment of the resource in a subscription.
